(19) United States
(12) Patent Application Publication
(10) Pub. No.: US 2022/0333741 A1
(43) Pub. Date: Oct. 20, 2022

(54) IMPROVEMENTS IN OR RELATING TO A METERING DEVICE

(71) Applicant: BBOXX LTD, London (GB)

(72) Inventors: Paul BUETTNER, London (GB); Joseph Luke FEARON, London (GB); Thomas James HOWARTH, London (GB); Fabian IRIARTE, London (GB); Paolo NAZZARI, London (GB); Kyle Stuart Reid MCINNES, London (GB); Richard Charles WILLIAMS, London (GB)

(73) Assignee: BBOXX LTD, London (GB)

(21) Appl. No.: 17/762,907

(22) PCT Filed: Sep. 23, 2020
(86) PCT No.: PCT/GB2020/052305

§ 371 Date: Mar. 23, 2022

(30) Foreign Application Priority Data
Sep. 23, 2019 (GB) 1913698.5

(51) Int. Cl. F17C 13/02; F17C 13/04; F17C 9/00

(52) U.S. Cl. CPC F17C 13/02; F17C 13/04; F17C 9/00; F17C 2205/0326; F17C 2250/0443; F17C 2205/0332; F17C 2221/035; F17C 2250/0636; F17C 2260/038; F17C 2260/028; F17C 2250/03; F17C 2205/0338; F17C 2265/04

(57) ABSTRACT

A metering device for attaching to a container configured to store a fluid, the device including: a valve configured to control the amount of fluid dispensed from the container; a user interface comprising at least one control configured to operate the valve between an open position and a closed position; and a control circuit configured to set a threshold amount of the fluid to be dispensed from the container, where the control circuit is configured to override the user interface and close the valve when the threshold amount of fluid to be dispensed has been reached.

### BACKGROUND

This invention relates to improvements in or relating to a metering device, and in particular, to a metering device configured to control the flow of a fluid, such as Liquefied Petroleum Gas (LPG), from a container, such as a gas canister.

Today, around 2.8 billion people lack access to ‘clean cooking’ and as a result, they rely on solid biomass fuels such as fire wood and charcoal and traditional cook stoves to cover their daily cooking needs. Generally the population growth in Sub-Saharan Africa (SSA) is outpacing efforts in gaining access to modern cooking. If this trend continues, United Nations' Sustainable Development Goal 7 of reaching universal energy access by 2030 will certainly not be reached.

The negative impacts of cooking dependency on solid biomass and traditional stoves are well known and manifold. They are highly polluting in terms of particular matter, CO₂ and other pollutants, thus majorly contributing to global indoor and outdoor air pollution. The household air pollution caused by solid biomass cooking fuel burning is associated with close to 4 million deaths yearly, mainly women and children under 5 years old located in low-middle income countries in Africa and Southeast Asia.

LPG is an efficient, clean and safe cooking fuel that has the potential to deliver substantial benefits for health, climate and environment when transitioning from solid biomass dependence. It is widely available across geographic regions in SSA. However, to date only 7% of SSA's population is using LPG for cooking. A lack of cost comparison between LPG and fuelwood/charcoal cooking may discourage adoption of LPG. The relative costs are perceived higher for LPG compared to solid fuels which can be purchased on a daily basis in small amounts, whereas LPG users are obliged to purchase a 12-15 kg canister which will provide sufficient gas for several weeks' or even months' requirements, but requiring a single up-front payment thus requiring savings strategies to avail disposable income at the moment of purchase.

It is against this background that the present invention has arisen.

### SUMMARY

According to the present invention there is provided a metering device for attaching to a container configured to store a fluid, the device comprising: a valve configured to control the amount of fluid dispensed from the container; a user interface comprising at least one control configured to operate the valve between an open position and a closed position; and a control circuit configured to set a threshold amount of the fluid to be dispensed from the container, wherein the control circuit is configured to override the user interface and close the valve when the threshold amount of fluid to be dispensed has been reached.

The user interface enables the user to control the amount of fluid being dispensed and when the fluid is to be dispensed.

The user interface may be a mechanical valve or switch which is directly operated by the user. Alternatively, the user interface may be an electronic valve or switch operated by a separate control, such as a button or touch screen, located on a user interface, which may comprise an LCD screen.

The amount of fluid dispensed may be measured using the mass of fluid dispensed. Alternatively, the weight, volume, and/or pressure could be used to control the amount of fluid dispensed. Monitoring the flow rate may also be pursued to determine the amount of fluid dispensed.

The amount of fluid in the container may further be determined by the time it would take for the container to empty, or drop below a predetermined threshold. This time may be predicted based on a user's usage patterns and history.

The threshold amounts of fluid available to the customer may be determined by the amount of credit a user has on an account, or by the amount of credit a user has pre-paid for. Alternatively, the user may pay directly for the fluid, during use. In this case, the threshold amount may be a standard predetermined amount, or the total amount of fluid in the container.

The container may be of a standard size or may be available in a plurality of sizes.

The metering device may operably connected to an output device, such as cooking equipment, that requires the fluid stored in the container.

The fluid may be dispensed in a plurality of discrete amounts.

Dispensing the fluid in a plurality of discrete amounts avoids waste as the fluid can remain in the container until it is needed by the user.

The valve may be configured to enable a plurality of fluid flow rates.

Enabling a plurality of fluid flow rates allows the user to more accurately control the amount of fluid being dispensed. It also allows the user to alter the flow rate for each specific use of the fluid, for example a variety of different flow rates may be required when being used to cook different foods, or when using different output devices, such as a kettle or a stove.

The metering device may comprise a connectivity module configured to connect the control circuit to a central processing unit.

Connection to a Central Processing Unit (CPU) via a connectivity module, which may comprise wireless networks, enables the device to be monitored remotely. The connectivity module also enables information to be collated and analyzed for a plurality of metering devices. The CPU may send information to the metering device regarding thresholds limits.

The control circuit may be configured to monitor the amount of fluid being dispensed from the container.

Monitoring the amount of fluid being dispensed enables an operative and/or CPU to predict when the user will run out of fluid and when replacement fluid will be required. The control circuit sends/receives information to/from the central processing unit via the connectivity module.

The amount of fluid dispensed is capped with the amount of fluid that the user has purchased. This amount is likely considerably smaller than the capacity of the container and therefore monitoring for available credit is a much more dynamic activity than monitoring for the fluid running out.

The device may comprise a housing containing the metering device.

The housing encloses all of the features of the metering device and protects them from the outside environment, such as rain, dust and the users. The housing may be sized according to the container or may be a standard size. Similarly, the connection between the housing and the container may be a universal connection or may vary depending on size and/or type of container used. The housing may be configured to tessellate with the inner surface of the neck of the container.

The housing may comprise a lockable collar configured to prevent the user from detaching the metering device from the container.

The lockable collar prevents the user from disconnecting the metering device from the container, and hence prevents the user from dispensing fluid that is not metered. The lock may be electrical or mechanical, and may be operated by a key or pin code. The lock may be configured such that it can only be unlocked by an operative. In some embodiments, the lock can only be unlocked when the system has an action assigned to the operative to unlock the unit, this needs to be confirmed by operative via connectivity initiated via an application on operative smart phone in vicinity of the unit.

A separate clip may be used to secure the cooking equipment to the metering device. This clip may prevent accidental detachment of the cooking equipment but may be intentionally detached and reattached by the user. The attachment may be a result of a screw thread connection or bayonet type fitting, for example.

The device may comprise a battery configured to power the metering device.

The battery allows the metering device to be used by people without access to electricity. The battery may be rechargeable in-situ.

The battery may be detachable from the housing.

A detachable battery can be replaced without disconnecting the entire metering device from the container. The battery may be enclosed within the housing of the metering device. Alternatively, the battery may be enclosed in a casing which is separate from the metering device housing, but that the metering device housing and battery casing tessellate and substantially fill the neck of the container. The battery casing may be removable from the metering device housing without removing the housing from the neck of the container. The battery cases may further be tamperproof locked.

The device may comprise connectivity to enable the battery to be recharged.

The connectivity may be in the form of a socket, wire or lead that can be connected to a solar panel, for example, to enable recharging of the battery in-situ. The recharging of the battery in-situ may be carried out by the user, which reduces the frequency with which an operative may need to service the metering device.

The battery may comprise a lock configured to prevent the use from detaching the battery from the housing.

The lock may prevent the user from removing the battery, hence ensuring the metering device remains functional.

The battery lock may comprise a first tamper detection mechanism configured to detect whether the battery has been removed from the housing.

The first tamper detection mechanism may alert the CPU if the user removes the battery, for example, if the user tries to use the battery for another device or tries to shut down the metering device.

The metering device may comprise a second tamper detection mechanism configured to detect the present of light within the housing.

Detecting tampering with the device ensures safety of the device and the user. The detection mechanism can also be used to alert an operative if the user attempts to steal fluid. The tamper detection mechanism may also alert the CPU if the user is trying to disconnect the metering device from the container by removing the lockable collar. The tamper detection mechanisms may be sensors configured to detect light in the housing, and hence determine when the housing has been opened. Alternatively or additional, a magnetic induction field mechanism connected using near field communications can also be used to detect tampering.

The metering device may comprise at least one sensor configured to monitor the air quality and/or temperature within the housing. In some embodiments, temperature and air quality sensors will only be operative when the device is in active mode (installed at the client). If the device is in transport or storage these sensors will not be operative.

Monitoring the air quality and/or temperature within the housing can be used to detect leaks, potential hazards and/or may be used to detect tampering with the system.

The temperature sensor(s) may be configured to monitor the temperature of the fluid, container, housing, battery and/or electrical components within the metering device. The temperature sensor may be used to detect overheating of at least one of the aforementioned components, such as the battery. Detected overheating may lead to “safety shut off” of the metering device, which causes the valve to close. Alternatively, “safety shut off” may occur when the temperature of a component reaches a predetermined level dictated by the manufacturer or supplier pf the component. For example, the “safety shut off” threshold may be 60° C. for a battery suited to this use. There may be a plurality of sensors and each sensor may have a different temperature limit.

Additionally, LPG in the canister is often cooler than air and therefore a decrease in temperature within the housing may also be used to detect leaks. The sensors may therefore be configured to detect a change in temperature away from a predetermined safe temperature.

At least one air quality sensors may be used to detect any safety adverse gas levels inside the housing. If gas is detected inside the housing, the “safety shut off” may be initiated via the control circuit and causes the valve to close. This may be an optional component for customers/markets with higher safety requests.

Alternatively, an external air quality sensor may be used to monitor the quality of the air in the vicinity of the metering device and/or container. This may be used during instillation, servicing and/or everyday use of the device and may be used to detect leaks.

The device may further comprise a safety valve, wherein the safety valve is operable between an open position and a closed position, wherein the valve is initially in the open position and wherein the closed position is configured to prevent the flow of fluid into the metering device.

The standard position for the safety valve is open. The safety valve enables the user to shut down the metering device manually in case of an emergency, hence reducing the risk of a hazard escalating. The safety valve may be directly connected to the container, to ensure the fluid does not enter the metering device when the safety valve is in the closed position.

The device may further comprise a memory configured to store data generated by the control circuit. The memory may be secure and encrypted.

The provision of a memory ensures that data is not lost in the event that the CPU or wireless network crashes. Monitoring of the device can continue and data may be uploaded to the CPU at a later date. The memory may store data such as fluid flow rate, amount of fluid in the container, amount of fluid available to the user (i.e. the threshold value) and/or time stamps of customer UI activities. The memory may also store data such as amount of credit the user has, state of charge of the battery, state of health of the battery, time to next service and/or the location of the metering device.

The user interface may be further configured to output one or more data stored in the memory. The functionality of the user interface may be augmented by connectivity with a technician device. When a technician is present and has a smart device enabled with a technician app, the connectivity between the microcontroller unit and the technician app can enable the user interface to provide additional information, including, but not limited to aggregated usage data, fault finding and debugging.

Outputting a selection of the stored data can be used to notify the user of the stored information such as those previously listed. Displaying data, such as remaining fluid levels or credit, may avoid unexpectedly running out of credit or battery.

The fluid may be Liquefied Petroleum Gas (LPG). LPG can be used in developing countries as a fuel for cooking. Additionally, the container may be a gas canister.

The device may further comprise a GPS tracker.

A GPS tracker allows the supplier to determine the exact location of the metering device. If a GPS tracker is not included then the operative installing the device and/or changing the gas canister may be responsible for providing/confirming the location of the metering device. The metering device may be presumed to remain in a single location.

Furthermore, according to the present invention there is provided a method for metering a fluid stored within a container, the container provided with a metering device comprising a valve configured to control the amount of fluid dispensed from the container, the method comprising: receiving payment for an amount of the fluid stored within the container; notifying the metering device of the amount of fluid purchased; unlocking the valve configured to control the amount fluid dispensed from the container; enabling a user to dispense the purchased amount of fluid from the container by operating a user interface comprising at least one control configured to open and close the valve, and wherein the metering device is configured to override the user interface and close the valve when the purchased amount of fluid has been dispensed.

The user interface enables the user to have control over the amount of fluid being dispensed and when the fluid is to be dispensed, without the need for a discrete volume tank. The user interface may be a mechanical control and/or switch or may be an electronic control operated via a button, which may be located on an LCD display/screen for example.

The payment may be received by mobile money, bank transfer, direct debit, standing order, cryptocurrency, cash or any other means of receiving imbursement for the fluid. The payment may be made by user or alternatively, the payment may be made, or contributed to, by a government subsidy, charity, supplier and/or friend/relative of the user.

The method may further comprise enabling the user to regulate the fluid being dispensed via the user interface. Regulating the fluid being dispensed may include controlling when the fluid is dispensed, via a binary ON/OFF functionality, and additionally using an analogue valve to control the flow rate at which the flow rate is dispensed. In particular, the purchased amount of gas can be dispensed in a plurality of discrete amounts.

Controlling the flow rate of the fluid being dispensed ensures that the fluid can be used in the most efficient and appropriate way by the user. The fluid flow rate may be adjusted using the first control of the user interface. Alternatively, the flow rate may be adjusted using a second control of the user interface.

Dispensing the fluid in a plurality of discrete amounts avoids waste as the fluid can remain in the container until needed.

The method may further comprise monitoring the characteristics of at least one of the metering device and the container.

Monitoring the characteristics may comprise monitoring at least one of: the amount of fluid being dispensed, temperature, air quality and/or whether tampering has occurred. Monitoring such characteristics may be used to predict when the fluid may run out and/or any potential issues, hazards or leaks with the device.

Monitoring the fluid usage may also be used to prevent the user from dispensing more than the purchased/threshold amount. It also can be used to inform the user of their remaining balance so they don't run out unexpectedly.

Monitoring the temperature may comprise monitoring the temperature of the fluid, container, metering device and/or any components within the metering device.

Monitoring the air quality may comprise monitoring the air quality in the metering device and/or in the vicinity of the device or container.

Monitoring whether tampering has occurred may be carried out in the metering device and/or in the collar configured to connect the metering device to the container.

The method may further comprise outputting a change in at least one characteristic to the user via the user interface.

Outputting the change in characteristics may comprise at least one of: notifying the user of the amount of purchased fluid remaining; a temperature of a component of the device; the air quality in the device; the state of charge of the battery; identifying that tampering has been detected; estimated dispensing time remaining.

Notifying the user, via the user interface, about a change in any of the above characteristics may result in the user shutting off the device before a serious issue occurs in order to prevent a risk or hazard from developing. It may also prevent the user from running out of fluid and/or credit unexpectedly.

The method may further comprise sending a change in at least one characteristics to a central processing unit.

Sending the change in characteristic to a CPU enables the external monitoring of a plurality of devices, which may be automated. This may enable the CPU to shut down the metering device as soon as a safety issue occurs or even before it develops.

The method may further comprise detecting for fluid leaks in the vicinity of the metering system and/or container using an external leak detection unit.

An external leak detection unit may more effectively detect a fluid leak. The external unit may be more expensive and/or more sensitive to a leak and therefore may be more likely to successfully detect a leak. The external unit may be used during installation, servicing or everyday usage of the metering device.

An additional leak detection unit (external AC powered), installed close to the output device, such as cooking equipment, may be connected to the meter device and lead to a “safety shut off” in case a leakage is detected. This may be an optional add-on for commercial customers to add more safety to the area. For example, where cooking equipment is connected to the metering device and is located at a distance from the metering device wherein internal leak detection sensors may not detect a leak in the vicinity of the cooking equipment.

The method may comprise the metering device with any of the features and/or embodiments described herein.

Furthermore, according to the present invention there is also provided a method for monitoring the characteristics of a plurality of metering systems each comprising a container and an associated metering device, the method comprising: maintaining an inventory of each metering system characteristics, wherein the characteristics include the location of the metering system; monitoring the changes in one or more of the characteristics; detecting when a change in one or more of the characteristics of a first metering system is outside a predetermined range; determining a response time based on the change of characteristic detected; and deploying an operative within the determined response time to address the change in characteristic.

When responding to a characteristic change, which may be referred to as servicing, the operative may address the change in characteristics by carrying out at least one of: replacing the container; refilling the container in-situ; replacing the battery; recharging the battery on site; recalibrating the metering system; recalibrating the sensors; testing for leaks.

Maintaining an inventory of the metering system characteristics, including locations, can help an operative to best service their assets. It enables the operative and/or CPU to determine when a metering system requires a service, or when the next service is likely to be required, so that the metering systems can remain active and functional.

The location may be input into the CPU by the operative. The operative may use an app on a mobile device to input the location of the metering system. The app may be configured to determine the location using the GPS of the mobile device. The location of the metering system may be updated during instillation, and/or servicing of the metering system to ensure that the metering systems can be serviced efficiently, and in good time, by the operative.

The battery may be changed or recharged each time the container is changed. The battery life may be at least equal to the time predicted for a user to dispense all the fluid from the container. Alternatively the battery life may be equal to twice the time predicted for a user to dispense all the fluid from the container.

The method may further comprise: identifying the metering systems located in the vicinity of the first metering system; and notifying the operative of the characteristic changes in each of the metering system in the vicinity of the first metering system. The identification of metering systems in the vicinity of the first metering system can either be achieved from the geolocation of the unit using the micro-controller unit of the first metering system to identify other metering systems in the vicinity via a ping or propagation communication. Alternatively, or additionally, the data can be retrieved from the inventory noting where systems have been installed in the vicinity of the first metering system. This data, however it is compiled, enables the operator to undertake intelligent route planning based on the location and level of need of intervention of neighbouring systems.

Notifying the operator of characteristic changes in nearby metering system will enable the operator to determine if multiple nearby services can be carried out in a single trip, hence increasing the efficiency of servicing a plurality of metering systems. For example, when a certain number of containers in one area are below a certain gas level threshold, wherein the time left in canister is more important than actual gas left, the CPU, or an operative, may calculate the optimal time and route for the operative to replace the containers. The metering systems in the vicinity of the first metering system may be the metering system located in the same street, village, town, region and/or country.

The characteristics of the metering system comprise at least one of: the amount of fluid store in the container; a temperature of at least one component of the metering system; the air quality in the metering system; whether tampering has occurred to the metering system; the state of charge of a battery configured to power the metering system.

Monitoring each of the above gives the following advantages: helps determine/predict when a container needs filling up/replacing; helps detects safety issues/hazards; helps detects safety issues/hazards; helps detects safety issues/hazards and/or whether a user is trying to bypass the metering device or associated charges; helps prevent the metering device from running out of battery and hence the above systems failing, respectively.

The system may be configured to triage between leaks and the rate of emptying of containers in order to determine the appropriate response time and most appropriate route for an operative to take during servicing of the metering systems.

The method may further comprise monitoring the live location of the metering system via GPS tracking.

Live monitoring may be used to determine if the user has moved the metering system away from the location in which it was installed. This can help to prevent an operative from traveling to a metering system to be serviced and discovering that the system is no longer there.

The invention will now be further and more particularly described, by way of example only, and with reference to the accompanying drawings.

### BRIEF DESCRIPTION OF THE FIGURES

FIG. 1 is a schematic of the metering system;

FIG. 2 is the metering system;

FIG. 3 is a method of receiving payment; and

FIG. 4 is a method of monitoring the characteristics of a metering system.

### DETAILED DESCRIPTION

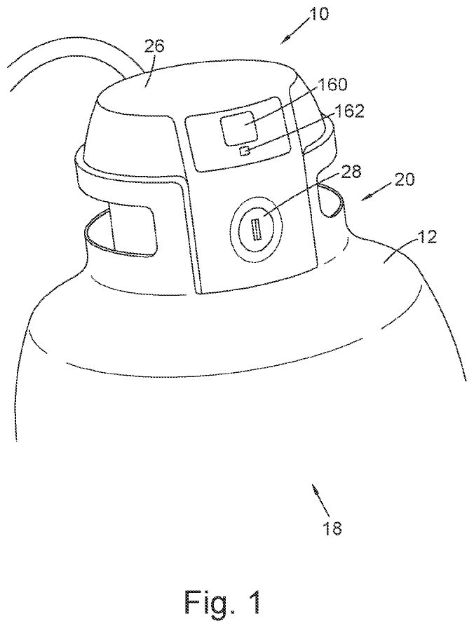

FIG. 1 shows a schematic of the metering system 20. The metering system 20, comprises a metering device 10 connected to a container 12. The container 12 is configured to store a fluid 18. The container 12 is a gas canister configured to store LPG. The metering device 10 comprises a housing 26 configured to contain all the components of the metering device 10 and a safety valve 28 configured to enable a manual shut down of the device. The device further comprises a user interface 160, which comprises an LCD screen and a plurality of controls 162 in the form of buttons. In one embodiment, the LCD screen may be touchscreen.

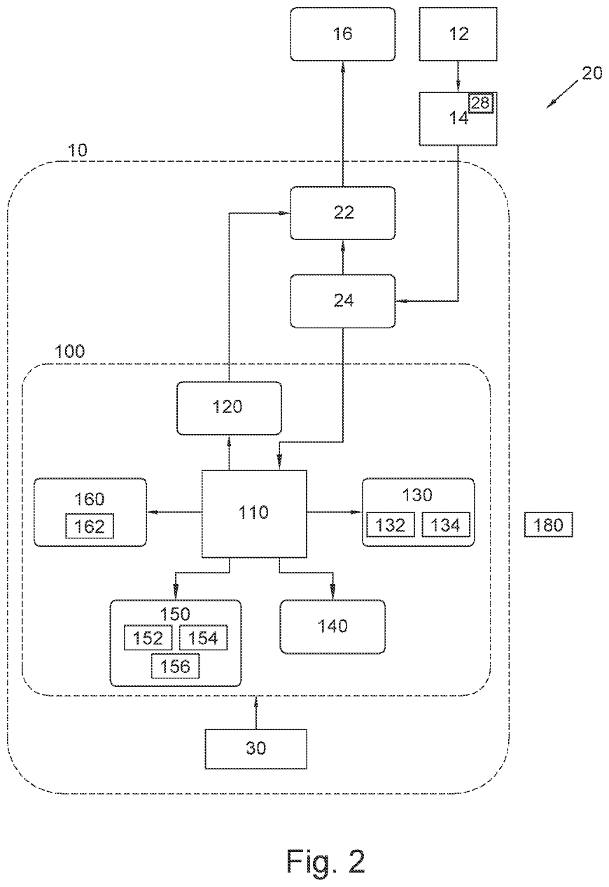

FIG. 2 shows a flow diagram of the metering system 20 connected between and output device 16, such as cooking equipment, and a container 12 comprising a pressure regulator 14. The container 12 is configured to store a fluid 18. In one embodiment of the invention, the container 12 is a gas canister configured to store liquefied petroleum gas (LPG).

The metering device 10 comprises a valve 22 configured to operate between an open position configured to allow fluid 18 to flow from the container 12 and a closed position configured to prevent fluid 18 from flowing from the container 12. The metering device further comprises a gas flow meter 24 configured to control the flow rate of fluid 18 from the container 12 when the valve 22 is in the open position. In one embodiment of the invention, the gas valve 22 may be partially opened and hence enable a plurality of different fluid flow rates out of the container 12. The valve 22 and the flow regulator 24 may therefore be combined into a single component.

The metering device 10 is powered by a battery 30. In one embodiment, the battery is rechargeable and can be recharged in-situ, whilst connected to the container 12. Alternatively, the battery may be replaced and/or recharged away from the container. In yet another embodiment, the battery is non-rechargeable and may be replaced each time it runs out of power. The battery is located in a casing detachable from the housing 26, but configured to tessellate with the housing such that the casing and housing fill the neck 13 of the container 12.

In a further embodiment, the metering device may be connect to a mains power supply, for example, a national, regional or other localised grid. This configuration will reduce the likelihood of power to the device being lost due to an empty battery and therefore data can continually be collected and gas can continually be metered effectively.

The metering device 10 further comprises a micro-control unit (MCU) 110.

The MCU comprises a control circuit 120 configured to set a threshold amount of the fluid 18 to be dispensed from the container 12.

The MCU also comprises a connectivity module 130 configured to connect the metering device 10 to a central processing unit (CPU) 180. The connectivity module comprises a Global System for Mobile Communications (GSM) module configured to establish a connection between the MCU and the CPU and an embedded Subscriber Identity Module (SIM) 134 configured to activate communications between the MCU and the CPU.

The metering device may have firmware default configuration parameters (i.e. gas calibration factor, credit type, conversion rate) but it may synchronize periodically, for example every hour, with the CPU to receive any pending configuration changes.

The MCU further comprises a flash memory 140 configured to store data generated and received by the metering system 20. The flash memory 140 may be a memory chip, for example a 16 Mb memory chip. The flash memory 140 is able to send the stored data to the CPU and receive data via the connectivity module 130.

Data may be sent via a message, which may be a mobile originated (MO) message (i.e. from the metering device to the CPU). MO messages may be: device status report (firmware version); current parts/peripheral connected to it (i.e. type of flow meter, battery, etc.); telemetry data (battery voltage, canister level, flow rate, event logs, etc) and/or request for synchronization with the CPU.

Alternatively, message may be mobile terminated (MT) messages (i.e. from the CPU to the metering device). MT messages may be: parameter/configuration change; request for synchronization with device; send command (i.e. reset).

When a control circuit is created in the factory, a serial number will be generated in a database and the CPU will be expecting messages coming from that end point. The first time the metering device comprising the control circuit connects to the CPU, the CPU will pick up the time and keep an internal real time clock (RTC) in the micro-controller unit running. This RTC will be use to generate the time-stamps for any MO message.

The metering device and CPU synchronize the configuration parameters when the metering device connects the first time and then periodically, for example every hour (MO). From this point, the metering device will operate normally, logging telemetry data, storing it into a file within a file system on the memory and sending it to the CPU every 1 hour, unless a manual synchronization takes places from the CPU. An MT message can be generated at any point from the CPU to force a configuration change or just received the latest telemetry data from the metering device.

Furthermore, the MCU comprises at least one sensor 150. In one embodiment, the MCU comprises at least one of an air quality sensor 152, a temperature sensor 154 and/or a temper detection mechanism 156.

The air quality sensor 152 may comprise of a plurality of sensors and is configured to monitor the air quality inside the housing of the metering device 10. The sensor 152 monitors the compounds and/or molecules present in the surrounding air to determine if the fluid 18 may have leaked from inside the container 12 or the fluid channels through the metering device 10. The leak may be identified when the fluid inside the container is detected to be present, above a predetermined threshold, in the air within the housing. Alternatively, the sensor 152 may be configured to detect the presents of the fluid in the air in the vicinity of the metering system 20. The sensor may also detect if a volatile or potentially dangerous and/or hazardous compound or molecule is present inside or within the vicinity of the metering system. A detection of this sort may cause the metering device to alter, or prevent, a fluid flow from the container. As a result, a potential hazard or safety risk may be avoided.

The temperature sensor 154 may comprise of a plurality of sensors configured to monitor the temperature of at least one of: the air within metering device; a component within the metering device; the battery; the container and/or the air surrounding the container. A sudden or drastic change in any one of the aforementioned temperatures away from a base temperature may be due to a potential hazard, malfunction and/or fluid leak and therefore the creation of a potentially hazardous environment surrounding the container. As a result, the metering system may alter, or prevent, the flow of fluid from within the container.

The tamper detection mechanism 156 may comprise of a plurality of sensors and is configured to determine if a user has tampered with the metering device 10, the container 12 and/or the connection there between. The tamper detection mechanism 156 may also detect if the user tampers with the connection between the metering system and the cooking equipment. One tamper detection mechanism 156 is coupled to a collar 158 configured to secure the metering device 10 to the container 12 in a way that prevents a user from disconnecting the metering device from the container without alerting the tamper detection mechanism 156. The tamper detection mechanism(s) 156 are configured to produce an alert when light is detected above a predetermined threshold. The alert may therefore be activated if the housing of the device is broken or opened, and the alert is configured to notify the CPU and/or produce an output via the MCU.

For example, the tamper detection mechanism may be a photo-transistor for ambient light. The photo-transistor may be connected to an ADC input in the micro-controller unit through in-house designed circuitry to be able to read an analogue voltage from 0V (dark) to 3.3V (saturated bright). The resolution of the ADC may be of 12 bit and so the value may vary from 0 to 4095. To avoid false positive alerts, a number of samples may be taken and a filtering algorithm based on standard deviation may take place to discard unwanted readings.

Alternatively, or in addition, the tamper detection mechanism may be a surface mount limit switch operably connected to the control circuit. This connectivity may be achieved by soldering the switch onto the PCB. After correct assembly of the housing this switch is pressed and the micro-controller unit is able to sense this by via an inputs. The firmware expects this input to be normally active, and if this is not the case (i.e. tampering occurs), a software interrupt is generated and a tamper alert (event log) is sent to the CPU.

The MCU further comprises a user interface 160 configured to provide the user with control over certain features of the invention. The user interface 160 comprises at least a first control 162, in the form of a button, configured to operate the valve 22 between an open position and a closed position. The user interface 160 may comprise a second button configured to control the flow meter 24, and hence the flow rate of fluid 18 from the container 12. As previously specified, the first and second button may be combined so that the valve 22 and flow meter 24 are controlled by a single button on the user interface 160. The user interface 160 further comprises an LCD display configured to present information to a user. Such information may comprise: amount of fluid in the container; amount of purchased fluid in the container; state of charge of the battery; state of health of the battery; whether the valve is open or closed; flow rate of fluid when valve is open; air quality, temperature and/or tamper detection mechanism alerts; and connectivity information with the CPU.

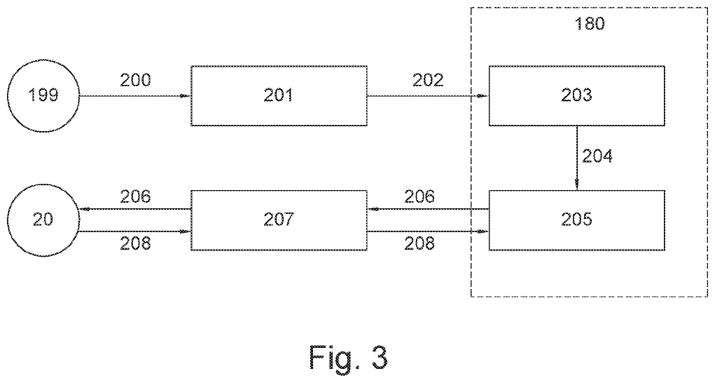

FIG. 3 shows a method of receiving payment, wherein the metering system 20, comprising the metering device 10 locked on top of the container 12, makes use of machine-to-machine (M2M) connectivity, digital finance and mobile coverage. From the user's perspective, the main objective of this metering system is to remove upfront cost of the container 12, output devices 16, such as cooking equipment, and fluid 18 bulk purchases by offering user's to pre-pay for small amounts of fluid 18 over time according to their cash flow availability.

A user may use mobile money to top up credit on their metering system 20 using the following steps:
1) The user makes a payment towards their metering system payment account through a mobile network operator (MNO) using mobile money via an unstructured supplementary service data (USSD) menu;
2) An instant payment notification is sent to a metering system payment service module located within the central processing unit (CPU);
3) The metering system payment service module turns the payment into credit based on the user's contract and sends it to the machine-to-machine (M2M) service module;
4) The M2M service module sends credit via mobile network operators (MNO) global system for mobile communications (GSM) network to the metering system; and
5) The metering system receives credit and sends confirmation back to M2M service module.

In some embodiments of the invention, the user can use cash, cheques, bank transfer, direct debits, cryptocurrencies or any other suitable means to buy credit. Users may also buy fluid directly whilst using the metering device, or buy the container and/or all the fluid stored therein.

Any credit data is stored in the internal memory of the micro-controller unit, for example in a 2048 bytes sector. A wear levelling technique may be implemented for memory endurance.

Further, when making payments through the USSD menu of the mobile money provider for the metering system payment account, the money is sent to the mobile network operators (MNOs) mobile money platform. This triggers a notification to metering system payment service module which is a module of user, operations and asset management platform “Pulse”. The platform adds this payment to the user contract and turns the payment into credit according to defined business rules and market-based pricing models. The credit is then sent to the metering system via the product management module as part of “Pulse”. The newly sent credit then reflects on the user interface 160 of the metering system 20 as added credit to the current credit balance. The current credit balance corresponds to the amount of purchased fluid. The user can then use this credit to dispense the fluid 18 from the container 12.

A user may also pay a monthly rate over a period of time, such as 6-months, which results in the user owning the output device 16. Users can then continue to pay for fluid 18, such as LPG, on a pay-as-you-cook basis using mobile money. This allows the user to spend as little as 0.5 USD to cook with LPG stored within a container 12 such as a gas canister. The price per kg LPG includes a premium to cover the costs of financing the gas inside the container 12, the container itself and the metering device 10 as well as the service cost of the metering system and the delivery and collection of the container during services.

From the fluid distributor perspective, with the described metering system, last mile distributors are able to offer consumer finance to fluid, such as LPG, user with reduced risk since users pre-pay for a certain amount of fluid. The flow of fluid stops when users run out of pre-paid credit, which gives them an incentive to pay via mobile money for new cooking gas again. The unsold portion of the fluid inside the container, the container itself and the metering device may remain property of the distributor. This allows fluid, and more specifically LPG, distributors to explore new user segments that were not able to afford this modern cooking fuel before.

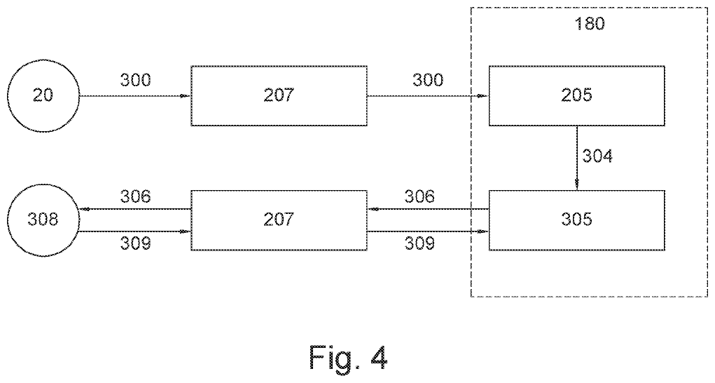

FIG. 4 shows a method of monitoring the characteristics of a metering system. The metering system comprises a container 12 and a metering device 10, wherein the characteristics of the metering system are monitored using the following steps:
1) The metering system sends information, such as system performance, container fluid lever level and user usage via the MNO GSM network to the M2M communication service module;
2) the M2M communication service module determines whether a response is needed, such as maintenance or due container fluid level being low;
3) In cases where a response is required, the M2M communication service module sends an alert to technician action engine;
4) The technician action engine sends service information to a technician app via the GSM network;
5) A technician receives a service request via the technician app and confirms an action performance via app.

The M2M technology enables distributors to optimize logistics routes based on remotely monitored container fluid levels, e.g. once more than a critical number of containers are below a certain fluid level in a concentrated area a logistic route will be recommended by the CPU, or operative, reducing costs of servicing this area more frequently than necessary, hence reducing overall transport costs.

Additionally, users will never be subjected to an empty fluid container since the fluid delivery service is coupled with automated operative actions. These are triggered through an enterprise resource planning (ERP) system when the metering system detects and communicates via M2M that the container fluid level is low. Furthermore, safety checks and user education during installation and every service action performed by certified operative increases awareness on safety and adoption of fluids based cooking, such as LPG, over cooking with solid biomass.

Additionally, based on the collected data and the monitored container fluid levels, the user demand can be predicted to optimize stock planning and reduce working capital needs.

1-24. (canceled)

25. A system for managing the distribution of a fluid, wherein the fluid is stored in containers, each container being provided with a metering device, the system comprising:
a plurality of metering devices each attached to a fluid container and each comprising:
a valve configured to control the amount of fluid dispensed from the container;
a user interface comprising at least one control configured to open and close the valve; and
a control circuit configured to set a threshold amount of the fluid to be dispensed from the container;
wherein the control circuit is configured to override the user interface and close the valve when the purchased amount of fluid has been dispensed;
a data store that stores:
data relating to a plurality of users;
data relating to the plurality of metering devices; and
data relating to a plurality of operatives; and
processing circuitry configured to:
receive payment from a user for an amount of the fluid stored within the container;
determine from the data store, the identity of the metering device and container in possession of the user;
notify the metering device of the amount of fluid purchased;
instruct the unlocking of the valve configured to control the amount fluid dispensed from the container.

26. The system according to claim 25, wherein the device is configured to dispense the fluid in a plurality of discrete amounts.

27. The system according to claim 25, wherein the valve of the metering device is configured to enable a plurality of fluid flow rates.

28. The system according to claim 25, wherein the device further comprises a connectivity module configured to connect the control circuit to the processing circuitry and wherein the processing circuitry is further configured to receive data from the device and update the data store with the received data.

29. The system according to claim 25, wherein the control circuit of the device is configured to monitor the amount of fluid being dispensed from the container.

30. The system according to claim 25, further comprising a housing containing the metering device.

31. The system according to claim 30, wherein the housing comprises a lockable collar configured to prevent the user from detaching the metering device from the container.

32. The system according to claim 25, wherein the metering device further comprises a battery configured to power the metering device.

33. The system according to claim 32, wherein the battery comprises a lock configured to prevent the use from detaching the battery from the housing.

34. The system according to claim 33, wherein the battery lock comprises a first tamper detection mechanism configured to detect whether the battery has been removed from the housing.

35. The system according to claim 30, wherein the metering device comprises a second tamper detection mechanism comprising a sensor configured to detect the present of light within the housing.

36. The system according to claim 25, wherein the metering device further comprises a safety valve, wherein the safety valve is operable between an open position and a closed position, wherein the valve is initially in the open position and wherein the closed position is configured to prevent the flow of fluid into the metering device.

37. The system according to claim 25, wherein the metering device further comprises a memory configured to store data generated by the control circuit.

38. The system according to claim 25, wherein the fluid is liquefied petroleum gas.

39. The system according to claim 25, wherein the metering device further comprises a GPS tracker.

40. The system according to claim 25, wherein the user interface enables the user to regulate the rate of fluid being dispensed.

41. The system according to claim 25, wherein the processing circuitry and/or the metering device is further configured to monitor the characteristics of at least one of the metering device and the container.

42. The system according to claim 41, wherein the metering device is configured to output a change in at least one characteristic to the user via the user interface.

43. The system according to claim 41, further comprising sending a change in at least one characteristics to the processing circuitry which is further configured to receive data from the device and update the data store with the received data.

44. The system according to claim 25, further comprising an external leak detection unit configured to detect fluid leaks in the vicinity of the metering device and/or container.

45. The system according to claim 25, wherein the data relating to the plurality of metering devices includes a plurality of characteristics of each metering device,
wherein the processing circuitry is configured to:
receive data from the metering device;
compare received data with data previously provided and stored in the data store and to identify a change in one or more of the characteristics;
detect when a change in one or more of the characteristics of a first metering system is outside a predetermined range;
determine a response time based on the change of characteristic detected; and
select and deploy an operative within the determined response time to address the change in characteristic.

46. The system according to claim 45, further comprising:
identifying other metering systems located in the vicinity of the first metering system; and
notifying the operative of the characteristic changes in each of the metering system in the vicinity of the first metering system.

47. The system according to either of claim 45, wherein the characteristics of the metering system comprise at least one of:
the amount of fluid store in the container;
a temperature of at least one component of the metering system;
the air quality in the metering system;
whether tampering has occurred to the metering system; and
the state of charge of a battery configured to power a the metering system.

48. The system according to claim 45, further comprising monitoring the live location of the metering system via GPS tracking.
